(19) United States
(12) Patent Application Publication
(10) Pub. No.: US 2024/0147556 A1
(43) Pub. Date: May 2, 2024

(54) COMMUNICATION OF PERIPHERAL DEVICES VIA WIRELESS CONNECTIONS

(71) Applicant: Hewlett-Packard Development Company, L.P., Spring, TX (US)

(72) Inventors: Min-Hsu Chuang, Taipei City (TW); Xin-Chang Chen, Taipei City (TW); Pai-Cheng Huang, Taipei City (TW); Chin-Hung Ma, Taipei City (TW); Shih-Yen Cheng, Taipei City (TW)

(21) Appl. No.: 17/976,088

(22) Filed: Oct. 28, 2022

(51) Int. Cl. H04W 76/15; H04B 17/318; H04W 76/25

(52) U.S. Cl. CPC H04W 76/15; H04B 17/318; H04W 76/25

(57) ABSTRACT

In some examples, a device can include a first antenna having a first wireless connection with a first computing device, a second antenna having a second wireless connection with a second computing device, and a controller to determine a signal strength of the first wireless connection and a signal strength of the second wireless connection, designate, in response to the signal strength of the first wireless connection being greater than a threshold signal strength, the first wireless connection as an active connection and the second wireless connection as a standby connection, and cause the peripheral device to communicate with the first computing device via the active connection of the first antenna while maintaining the second wireless connection to the second computing device via the second antenna, where the second wireless connection remains as the standby connection.

### BACKGROUND

Users of computing devices may utilize their computing devices for various purposes. A computing device can allow a user to utilize computing device operations for work, education, gaming, multimedia, and/or other general use. Certain computing devices can be portable to allow a user to carry or otherwise bring with the computing device while in a mobile setting, while other computing devices may not be portable but allow a user to utilize the computing device in an office or home setting.

### BRIEF DESCRIPTION OF THE DRAWINGS

FIG. 1 illustrates an example of a diagram of a system for communication of peripheral devices via wireless connections.

FIG. 2A illustrates a diagram of an example peripheral device.

FIG. 2B illustrates a diagram of an example peripheral device.

FIG. 3 illustrates a block diagram of an example of a system for communication of peripheral devices via wireless connections.

### DETAILED DESCRIPTION

A user may utilize a computing device for various purposes, such as for business and/or recreational use. As used herein, the term “computing device” refers to an electronic system having a processor resource and a memory resource. Examples of computing devices can include, for instance, a laptop computer, a notebook computer, a desktop computer, an all-in-one (AIO) computer (e.g., a computing device in which computing hardware and a display device are included in a single housing), a mobile device, among other types of computing devices.

Certain computing devices can utilize an antenna for wireless connection or communication with other devices. As used herein, wireless connection refers to receiving and/or transmitting information without a solid connection such as wires or cables. Examples of wireless connections could include Bluetooth, Wi-Fi, broadband cellular networks, radio waves, or infrared light. As used herein, the term “antenna” refers to a device that converts radio waves into an electrical signal or vice-versa. For example, the antenna of the computing device can receive and/or transmit information (e.g., via radio waves) to a different computing device in order to communicate with the different computing device or any other device capable of wireless communication.

A peripheral device may communicate with a computing device via a wireless connection. As used herein, the term “peripheral device” refers to an auxiliary device to enter information into and/or get information out of a computing device. Examples of peripheral devices can include, for instance, a computer mouse, a computer keyboard, a remote control, camera, microphone, among other peripheral devices.

For certain communication types, a particular type and/or amount of antennas can be utilized that can provide a user of the computing device with a positive user experience. For example, the particular type and/or the amount of antennas can be chosen in order to allow for a peripheral device to wirelessly communicate with the computing device seamlessly to minimize communication wait time to send and/or receive information to and/or from other devices.

A peripheral device may connect to multiple computing devices using multiple connections. However, it can be difficult to use a peripheral device with multiple computing devices. For example, a user may utilize the peripheral device to communicate with a first computing device, but if the user wishes to communicate with a second computing device, the user may have to physically alter a switching mechanism to communicate with the second computing device. Such switching mechanisms can result in the peripheral device being connected/reconnected as the user wishes to interact with each new device. As a result, switching between various computing devices can be a time consuming and frustrating effort.

Communication of peripheral devices via wireless connections according to the disclosure can allow a peripheral device to maintain a connection with multiple computing devices simultaneously while designating a particular computing device to be in communication with the peripheral device. When in communication with a computing device, the peripheral device can input information into and/or get information out of the computing device. Such information can be a result of a user interaction with the peripheral device, such as providing an input to the peripheral device. As used herein, the term “input” refers to introduction of data to a computing device. For example, a user can input data, such as characters, letters, numbers, directional inputs, and/or other data via buttons, keys, and/or joysticks, among other input mechanisms. By utilizing the signal strength of each connection to each computing device, the peripheral device may switch between computing devices for communication therewith automatically. Such a device can help improve the user experience as compared with previous approaches when using a single peripheral device with multiple computing devices simultaneously by allowing the user to automatically switch between which computing device they are currently interacting with.

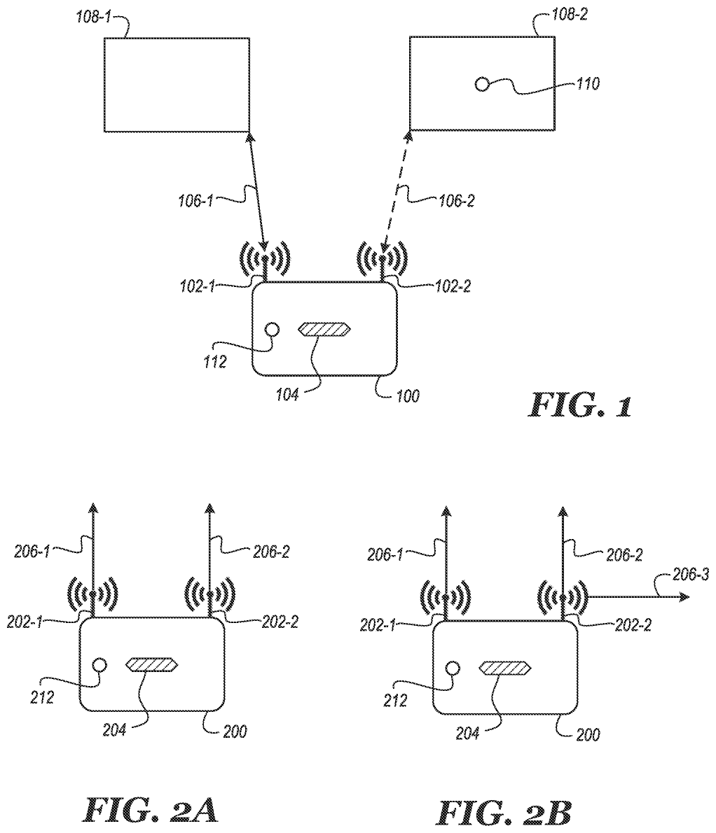

FIG. 1 illustrates an example of a diagram of a system for communication of peripheral devices via wireless connections. As illustrated in FIG. 1, the system can comprise a first computing device 108-1 a second computing device 108-2, and a peripheral device 100. The peripheral device 100 can include a first antenna 102-1 having an active first wireless connection 106-1 with the first computing device 108-1, and a second antenna 102-2 having a standby second wireless connection 106-2 with the second computing device 108-2.

As illustrated in FIG. 1, the peripheral device 100 can have a wireless connection with the first computing device 108-1 and the second computing device 108-2. Examples of such a wireless connection can include a local area network (LAN), wide area network (WAN), personal area network (PAN), a distributed computing environment (e.g., a cloud computing environment), storage area network (SAN), Metropolitan area network (MAN), a cellular communications network, Long Term Evolution (LTE), visible light communication (VLC), Bluetooth, Worldwide Interoperability for Microwave Access (WiMAX), Near Field Communication (NFC), infrared (IR) communication, Public Switched Telephone Network (PSTN), radio waves, and/or the Internet, among other types of wireless connections.

The wireless connections between the peripheral device 100 and the first computing device 108-1 and the second computing device 108-2 can include various designations, and such designations can be based on the orientation of the peripheral device 100 with respect to the first computing device 108-1 and the second computing device 108-2, as is further described herein. For example, such designations can include an active connection and a standby connection. As used herein, the term “active connection” refers to a connection between a peripheral device and a computing device where inputs by a user to the peripheral device are communicated to the computing device. For example, if the active connection is with the first computing device, inputs by a user are communicated to the first computing device. As used herein, the term “standby connection” refers to a connection between a peripheral device and a computing device where inputs by a user to the peripheral device are not communicated to the computing device. For example, if the standby connection is with the second computing device, inputs by a user are not communicated to the second computing device. The designation of active connection or standby connection indicates that a wireless connection is to be used as an active connection or a standby connection.

In order to determine the orientation of the peripheral device 100 with respect to the first computing device 108-1 and the second computing device 108-2, the peripheral device 100 can utilize a signal strength of the first wireless connection 106-1 and a signal strength of the second wireless connection 106-2, Based on the signal strengths, the peripheral device 100 can designate the wireless connections as active and standby, as is further described herein.

The peripheral device 100 can include a controller 104 to determine a signal strength of the first wireless connection 106-1 and a signal strength of the second wireless connection 106-2. As used herein, the term “signal strength” refers to the power of the signal being received. For example, the received signal strength indication (RSSI), a measure of the power present in a received radio wave such as Bluetooth may use, can be used as a way to quantifying signal strength. The controller 104 can compare the signal strength of the first wireless connection 106-1 and the signal strength of the second wireless connection 106-2 to a threshold signal strength and based on the comparison, designate an active connection and a standby connection. The threshold signal strength can be predetermined or calculated. The threshold signal strength can be an absolute value, a relative value to the signal strengths, a ratio of one signal strength to a second signal strength, or value determined by any other method.

Using antennas with beamforming technology may allow for different RSSI values depending on the orientation of the peripheral device 100 to the first computing device 108-1 and the second computing device 108-2, For example, the controller 104 may use the RSSI values of the first wireless connection 106-1 and the second wireless connection 106-2 as a proxy for the orientation of the of the peripheral device 100 to the first computing device 108-1 and the second computing device 108-2. By comparing those RSSI values to a threshold value, the controller 104 may be able to determine whether the peripheral device is oriented towards the first computing device 108-1 or the second computing device 108-2. For example, the peripheral device may be oriented towards the first computing device 108-1 and not oriented towards the second computing device 108-2. The controller 104 can determine the RSSI of the first wireless connection 106-1 to be −25 decibel-milliwatts (dBm) and the RSSI of the second wireless connection 106-2 to be −55 dBm. The controller 104 can compare the RSSI of the first wireless connection 106-1 (e.g., −25 dBm) and the RSSI of the second wireless connection 106-2 (e.g., −55 dBm) with a threshold signal strength (e.g., −50 dBm). Based on the comparison, the controller 104 may determine the RSSI of the first wireless connection 106-1 to be greater than the threshold value, and the RSSI of the second wireless connection 106-2 to be less than the threshold value. The controller 104 may designate the first wireless connection 106-1 as the active connection, and the second wireless connection 106-2 as the standby connection.

Although the controller 104 is described above as comparing RSSI values of the wireless connections 106-1, 106-2 to a threshold value, examples of the disclosure are not so limited. For example, the controller 104 may designate the active and standby wireless connection, such as by using the angle of arrival (AoA) and/or angle of departure (AoD) of the first wireless connection and the second wireless connection, or by comparing the RSSI value at the first antenna 102-1 of the first wireless connection 106-1 and the RSSI value at the second antenna 102-1 of the first wireless connection 106-1, which may be different depending on the position of each antenna relative to each computing device based on the orientation of the peripheral device, to the difference in RSSI values of the second wireless signal 106-2 at the first antenna 102-1 and the second antenna 102-2.

The controller 104 can monitor the signal strength of the first wireless connection 102-1 and the second wireless connection 102-2. For example, the controller 104 can periodically sample (e.g., determine) the signal strengths of the first wireless signal 106-2 and second wireless signal 102-2 at predetermined intervals and/or in response to an input to the peripheral device. Such an input may include the peripheral device being moved, a button being pressed, and/or any other input.

The controller 104 can compare the additional signal strengths of the first wireless connection 106-1 and second wireless connection 106-2 to the threshold signal strength, and based on the comparison, the controller 104 can switch the designation of the first wireless connection 106-1 and the second wireless connection 106-2. For example, if the peripheral device 100 is moved from being oriented towards the first computing device 108-1 to being oriented towards the second computing device 108-2, the controller 104 can determine an additional RSSI of the first wireless connection 106-1 to be −30 dBm, and an additional RSSI of the second wireless connection 106-2 to be −95 dBm. The controller 104 can compare the additional RSSI of the first wireless connection 106-1 (e.g., −30 dBm) and the additional RSSI of the second wireless connection 106-2 (e.g., −95 dBm) with a threshold signal strength (e.g., −50 dBm). Based on the comparison, the controller 104 can determine the RSSI of the first wireless connection 106-1 to be lower than a threshold value threshold value and the RSSI of the second wireless connection 106-2 to be greater than the threshold value. The controller 104 may switch the designation of the first wireless connection 106-1 from active connection to standby connection, and switch the designation of the second wireless connection 106-2 from standby connection to active connection.

While the controller 104 is described above as comparing the signal strengths to a threshold signal strength, examples of the disclosure are not so limited. For instance, in some examples, the controller 104 can compare the signal strength of the first wireless connection 106-1 and the second wireless connection 106-2 with a signal strength range. For example, the controller 104 can determine an additional RSSI of the first wireless connection 106-1 to be −25 dBm, and an additional RSSI of the second wireless connection 106-2 to be −75 dBm. The controller 104 can compare the additional RSSI of the first wireless connection 106-1 (e.g., −25 dBm) and the additional RSSI of the second wireless connection 106-2 (e.g., −75 dBm) with a threshold signal strength range (e.g., −40 dBm to −60 dBm), Based on the comparison, the controller 104 may determine the RSSI of the first wireless connection 106-1 to be lower than the minimum of the threshold signal strength range and the RSSI of the second wireless connection 106-2 to be greater than the maximum of the threshold signal strength range. The controller 104 can switch the designation of the first wireless connection 106-1 from active connection to standby connection, and switch the designation of the second wireless connection 106-2 from standby connection to active connection.

The controller 104 can prevent a change of designation where either signal strength falls between threshold range of values (e.g., −40 dBm to −60 dBm) such as, continuing from the previous example, if the controller 104 determines the RSSI of the first wireless connection 106-1 to be −46 dBm. After switching the designation of the second wireless connection 108-2 to the active connection and the designation of the first wireless connection 106-1 to the standby connection, the controller 104 may communicate with the second computing device 108-2 via the second wireless connection 106-2 while maintaining the first wireless connection 106-1 to the first computing device 108-1 via the first antenna 102-1, wherein the first wireless connection 106-1 remains connected as the standby connection.

As used herein, “maintaining a connection” refers to a continued relationship between two devices where the two devices can communicate information between each other regardless of whether user inputs are communicated. Maintaining a connection can be contrasted with two devices that are paired but disconnected, where “pairing” two devices refers to registering information with a first device so that a second device can make a connection with the first device to transmit information therebetween. The communication via the active wireless connection 106 can include the peripheral device 100 transmitting an input to the peripheral device 100 to a computing device 108 via the active wireless connection 106.

A variety of mechanisms to supplement switching designations of the active wireless connection and standby connection may be utilized. Such confirmation conditions may include utilizing a locking mechanism, determining an orientation of a user, utilizing a predetermined gesture, among other mechanisms, as is further described herein. The controller 104 may switch the designation of active connection and standby wireless connection when a confirmation condition is met at the same time the designation would be switched based on the signal strength of the first wireless connection 106-1 and the second wireless connection 106-2.

As mentioned above, one confirmation condition may include utilizing a mechanism 112. The mechanism 112 can be located in the peripheral device 100 to toggle an unlocked mode and a locked mode. When the mechanism 112 is in the locked mode, the controller 104 maintains the active connection and standby connection designations. Such a mechanism 112 can prevent the controller 104 from switching the designations when a user may not intend for such switching to occur. However, the user may provide an input to the mechanism 112 (e.g., switch the mechanism 112) so that when the mechanism 112 is in the unlocked mode, the controller 104 designates, or redesignates, the active connection and the standby connection. For example, if the peripheral device 100 is moved from being oriented towards the first computing device 108-1 to being oriented towards the second computing device 108-2 and the mechanism 112 is in the unlocked mode, the controller 104 can determine an additional RSSI of the first wireless connection 106-1 to be −30 dBm, and an additional RSSI of the second wireless connection 106-2 to be −95 dBm. The controller 104 can compare the additional RSSI of the first wireless connection 106-1 (e.g., −30 dBm) and the additional RSSI of the second wireless connection 106-2 (e.g., −95 dBm) with a threshold signal strength (e.g., −50 dBm). The controller 104 can determine the mechanism is in the unlocked mode, and based on the comparison, the controller 104 can determine the RSSI of the first wireless connection 106-1 to be lower than a threshold value threshold value and the RSSI of the second wireless connection 106-2 to be greater than the threshold value. The controller 104 may switch the designation of the first wireless connection 106-1 from active connection to standby connection, and switch the designation of the second wireless connection 106-2 from standby connection to active connection.

Another confirmation condition can include a device to determine an orientation of a user. As used herein, orientation refers to the position of an object in space. An orientation can be relative to another object. An orientation of a user may refer to the position of a user, or a portion of the user, relative to another object, such as the first computing device 108-1 and/or 108-2. The orientation of the user may be utilized to determine a focus of a user's attention (e.g., which computing device 108 the user is focusing on). In order to determine the orientation of the user, the second computing device 108-2 can include a camera 110 to determine the orientation of a user (not depicted) with respect to the second computing device 108-2. The orientation of the user can be used to supplement the designation of active and passive connection.

For example the orientation of the user may indicate where the user is directing their attention, so the orientation of the user can be used to help prevent unintentional switching of the active connection by preventing the switching to a new active connection when the user has not shifted their attention, even if the user may have changed the orientation of the peripheral device 100 with respect to the computing devices 108. However, the designation of the active wireless connection can be switched when the user and the peripheral device are both oriented towards the same standby computing device 108. For example, the controller 104 can switch the designation of the active wireless connection 106, from the first wireless connection 106-1 to the second wireless connection 106-2, in response to the signal strength of the first wireless connection 106-1 not exceeding a threshold signal strength while the signal strength of the second wireless connection 106-2 exceeds the threshold signal strength and the camera 110 captures the user being oriented towards the second computing device 108-2.

Another confirmation condition can include utilizing the peripheral device to perform a predetermined gesture. For example, peripheral device 100 may be a computer mouse, the first computing device 108-1 may be a first laptop computer, and the second computing device 108-2 may be a second laptop computer, which may include user interfaces. As used herein, a user interface refers to a display of information such as text, videos, images, or combinations thereof which may be displayed on an output device that includes a display panel that displays information provided by an electrical signal in a visual and/or tactile form. The computer mouse may communicate with the second laptop via the active connection allowing a user to manipulate a cursor on the user interface of the second laptop computer (e.g., the second wireless connection 106-2 is the active connection), while not manipulating a cursor on the user interface of the first laptop computer (e.g., the first wireless connection 106-1 is the standby connection).

When a user performs a confirmation gesture, such as making an “L” shaped motion with the mouse, and orients the computer mouse at the first laptop computer, the signal strength of the first wireless connection 106-1 may exceed the threshold signal strength and the signal strength of the second wireless connection 106-2 may not exceed the threshold signal strength. The controller 104 may switch the designation of the first wireless connection 106-1 to be the active wireless connection, and the designation of the second wireless connection 106-2 to the standby connection 106-1 and to communicate with the first computer via the active connection, thereby allowing the user to manipulate a cursor on the user interface of the first laptop computer while not manipulating the cursor on the user interface of the second laptop computer.

Although the confirmation conditions are described above as utilizing a locking mechanism, a camera 110 to determine an orientation of a user relative to the computing devices 108, or utilizing the peripheral device 100 to perform a predetermined gesture, examples of the disclosure are not so limited. For example, the system may utilize a combination of the above confirmation conditions and/or any other types of confirmation conditions.

FIG. 2A illustrates a diagram of an example peripheral device 200. The peripheral device 200 can include a first antenna 202-1, a second antenna 202-2, and a controller 204. The first antenna 202-1 can have a first wireless connection 206-1 with a first computing device (e.g., first computing device 108-1 as illustrated in FIG. 1.) The second antenna 202-2 can have a second wireless connection 206-2 with a second computing device (e.g., second computing device 108-2 as illustrated in FIG. 1.)

The controller may determine the designation of an active connection and a standby connection based on the signal strength of the first wireless connection 206-1 and the signal strength of the second wireless connection 206-2. For example, the controller 204 may designate, based on the signal strength of the first wireless connection 206-1 and the signal strength of the second wireless connection 206-2, the first wireless connection 206-1 as an active connection and the second wireless connection 206-2 as a standby connection. Examples of determining the designation can include the designation of the first wireless connection 206-1 as the active connection based on the signal strength of the first wireless connection 206-1 being greater than a threshold signal strength and the designation of the second wireless connection 206-2 as the standby connection based on the signal strength of the second wireless connection 206-2 being less than the threshold signal strength. The controller 204 may designate the active connection based on an orientation of the peripheral device determined based on information other than signal strength or based on information such as the angle of arrival or angle of departure of a wireless signal.

The controller 204 may cause the peripheral device 200 to communicate with one of the computing devices via the active wireless connection maintained by one antenna 202 while maintaining the standby connections with another antenna 202. For example, the controller 204 can cause the peripheral device 200 to communicate with the first computing device via the active connection of the first antenna 202-1 while maintaining the second wireless connection 206-2 to the second computing device via the second antenna 202-2, wherein the second wireless connection 206-2 remains as the standby connection.

The controller 204 may monitor the signal strength of the wireless connections 206, and switch the designation of the active and standby connection based on any changes in the signal strength of the wireless connections 206, A change in signal strength may occur, for example, when the peripheral device 200 is oriented in a different direction due to a user moving the peripheral device 200. After switching the active connection and standby connection designations, the controller 204 may cause the peripheral device 200 to communicate with the computing device connected to the peripheral device 200 via the newly designated active wireless connection 206 while maintaining the newly designated standby wireless connection 206,

FIG. 2B illustrates a diagram of an example peripheral device 200. Similar to the peripheral device of FIG. 2A, the peripheral device 200 can include a first antenna 202-1, a second antenna 202-2, and a controller 204. The first antenna 202-1 can have a first wireless connection 206-1 with a first computing device (e.g., first computing device 108-1 as illustrated in FIG. 1.) However, the second antenna 202-2 can have a second wireless connection 206-2 with a second computing device (e.g., second computing device 108-2 as illustrated in FIG. 1.) as well as a third wireless connection 206-3 with a third computing device.

The peripheral device 200 may maintain additional simultaneous connections with additional devices. For example, the peripheral device 200 can maintain an active connection with a first antenna 202-1 and maintaining additional standby connections with a second antenna 202-2 and comparing the signal strengths of all wireless connections 206 in determining which connection is to be the active connection. Additionally, the peripheral device 200 can maintain a third wireless connection 206-3 with a third computing device (e.g., not illustrated in FIG. 2B). The controller 204 may maintain the third wireless connection 206-3 with a third computing device via the second antenna 202-2.

The controller 204 may also determine a signal strength of the third wireless connection 206-3 and designate the third wireless connection 206-3 as an additional standby connection, based on the signal strength of the third wireless connection 206-3. The controller 204 may cause the peripheral device 200 to maintain the third wireless connection 206-3 to the third computing device via the second antenna 202-2, wherein the second wireless connection 206-2 remains as the standby connection and the third wireless connection 206-3 remains as the additional standby connection.

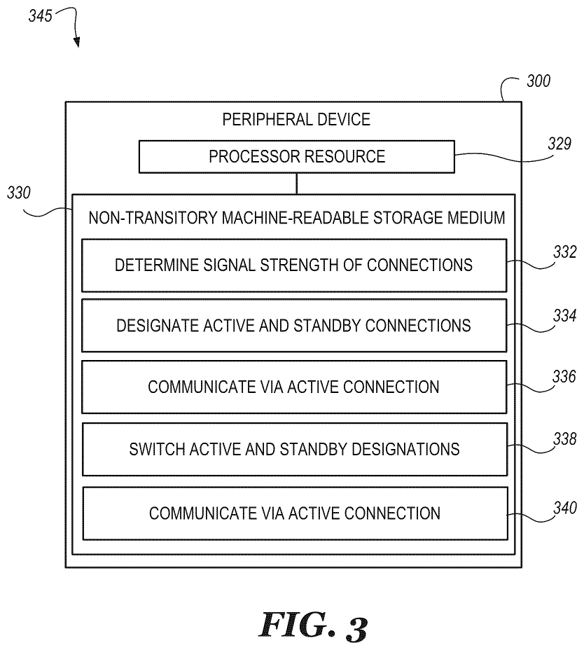

FIG. 3 illustrates a block diagram of an example of a system 345 for communication of peripheral devices via wireless connections. In the example of FIG. 3, system 345 includes a peripheral device 300 including a processing resource 329 and a non-transitory machine-readable storage medium 330. Although the following descriptions refer to a single processor and a single machine-readable storage medium, the descriptions may also apply to a system with multiple processors and multiple machine-readable storage mediums. In such examples, the instructions may be distributed across multiple machine-readable storage mediums and the instructions may be distributed across multiple processors, Put another way, the instructions may be stored across multiple machine-readable storage mediums and executed across multiple processors, such as in a distributed computing environment.

Processing resource 329 may be a central processing unit (CPU), microprocessor, and/or other hardware device suitable for retrieval and execution of instructions stored in the non-transitory machine-readable storage medium 330. In the particular example shown in FIG. 3, processing resource 329 may receive, determine, and send instructions 332, 334, 336, 338, 340. In another implementation, processing resource 329 may include an electronic circuit comprising a number of electronic components for performing the operations of the instructions in the non-transitory machine-readable storage medium 330. With respect to the executable instruction representations or boxes described and shown herein, it should be understood that part or all of the executable instructions and/or electronic circuits included within one box may be included in a different box shown in the figures or in a different box not shown.

The non-transitory machine-readable storage medium 330 may be any electronic, magnetic, optical, or other physical storage device that stores executable instructions. Thus, non-transitory machine-readable storage medium 330 may be, for example, Random Access Memory (RAM), an Electrically-Erasable Programmable Read-Only Memory (EEPROM), a storage drive, an optical disc, and the like. The executable instructions may be “installed” on the system 345 illustrated in FIG. 3. Non-transitory machine-readable storage medium 330 may be a portable, external or remote storage medium, for example, that allows the system 345 to download the instructions from the portable/external/remote storage medium. In this situation, the executable instructions may be part of an “installation package”.

Instructions 332, when executed by a processing resource such as processing resource 329, may cause system 345 to determine a signal strength of a first wireless connection and a second wireless connection. The first wireless connection may be between a first antenna and a first computing device and the second wireless connection may be between a second antenna and a second computing device.

Instructions 334, when executed by a processing resource such as processing resource 329, may cause the system 345 to designate active and standby connections. For example, the system 345 can designate the first wireless connection as an active connection based on the signal strength of the first wireless connection exceeding a threshold signal strength and the second wireless connection as a standby connection based on the signal strength of the second wireless connection not exceeding the threshold signal strength.

The instructions 336, when executed by a processing resource such as processing resource 329, may cause the system 345 to communicate via an active connection. For example, the system 345 can communicate with the first computing device via the active connection while maintaining the second wireless connection to the second computing device via the second antenna, where the second wireless connection remains as the standby connection.

The instructions 338, when executed by a processing resource such as processing resource 329, may cause system 345 to switch active and standby designations. For example, the system 345 can switch the designation of the first wireless connection to the standby connection and the designation of the second wireless connection to the active connection in response to the signal strength of the first wireless connection not exceeding the threshold signal strength and the signal strength of the second wireless connection exceeding the threshold signal strength.

The instructions 340, when executed by a processing resource such as processing resource 329, may cause the system 345 to communicate via the active connection. For example, the system 345 can communicate with the second computing device via the active connection while maintaining the first wireless connection to the first computing device via the first antenna, where the first wireless connection remains as the standby connection.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” can refer to one such thing or more than one such thing.

The figures herein follow a numbering convention in which the first digit corresponds to the drawing figure number and the remaining digits identify an element or component in the drawing. For example, reference numeral 104 may refer to element 104 in FIG. 1 and an analogous element may be identified by reference numeral 304 in FIG. 3. Further, repeated instances of an element within a single figure may be identified collectively by a single number followed by a letter to identify a specific instance of that element. For example, computing devices may be identified generically as “a computing device 108” while a specific computing device may be identified as “first computing device 108-1” or “second computing device 108-2. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples and data provide a description of the method and applications, and use of the system and method of the disclosure. Since many examples can be made without departing from the spirit and scope of the system and method of the disclosure, this specification merely sets forth some of the many possible example configurations and implementations.

What is claimed is:

1. A peripheral device, comprising:
a first antenna having a first wireless connection with a first computing device;
a second antenna having a second wireless connection with a second computing device; and
a controller to:
determine a signal strength of the first wireless connection and a signal strength of the second wireless connection;
designate, in response to the signal strength of the first wireless connection being greater than a threshold signal strength, the first wireless connection as an active connection and the second wireless connection as a standby connection; and
cause the peripheral device to communicate with the first computing device via the active connection of the first antenna while maintaining the second wireless connection to the second computing device via the second antenna, wherein the second wireless connection remains as the standby connection.

2. The peripheral device of claim 1, wherein the controller is to designate the second wireless connection as the standby connection in response to the signal strength of the second wireless connection being less than the threshold signal strength.

3. The peripheral device of claim 1, wherein the controller is to determine another signal strength of the first wireless connection and another signal strength of the second wireless connection.

4. The peripheral device of claim 4, wherein the controller is to switch, in response to the another signal strength of the second wireless connection exceeding the threshold signal strength and the another signal strength of the first wireless connection not exceeding the threshold signal strength, the designation of the first wireless connection to the standby connection and the designation of the second wireless connection to the active connection.

5. The peripheral device of claim 2, wherein the threshold signal strength is a range of signal strengths.

6. The peripheral device of claim 3, wherein the controller is to determine the another signal strength at a predetermined time interval.

7. The peripheral device of claim 3, wherein the control is to determine the another signal strength in response to an input to the peripheral device.

8. The peripheral device of claim 3, wherein the controller is to cause the peripheral device to communicate with the second computing device via the active connection of the second antenna while maintaining the first wireless connection to the first computing device via the first antenna, wherein the first wireless connection remains as the standby connection.

9. The peripheral device of claim 3, further comprising a mechanism to toggle an unlocked mode and a locked mode such that:
when the mechanism is in the locked mode, the controller maintains the active connection and standby connection designations; and
when the mechanism is in the unlocked mode, the controller designates the active connection and the standby connection.

10. The peripheral device of claim 1, wherein:
the second antenna further maintains a third wireless connection with a third computing device; and
the controller is to:
determine a signal strength of the third wireless connection;
designate, based on the signal strength of the third wireless connection, the third wireless connection as an additional standby connection; and
cause the peripheral device to maintain the third wireless connection to the third computing device via the second antenna, wherein the second wireless connection remains as the standby connection and the third wireless connection remains as the additional standby connection.

11. The peripheral device of claim 1, wherein the peripheral device transmits an input to the peripheral device to the first computing device via the active connection.

12. A non-transitory machine-readable storage medium storing instructions that when executed, cause a processor to:
determine a signal strength of:
a first wireless connection between a first antenna and a first computing device; and
a second wireless connection between a second antenna and a second computing device;
designate:
the first wireless connection as an active connection based on the signal strength of the first wireless connection exceeding a threshold signal strength; and
the second wireless connection as a standby connection based on the signal strength of the second wireless connection not exceeding the threshold signal strength;
communicate with the first computing device via the active connection while maintaining the second wireless connection to the second computing device via the second antenna, wherein the second wireless connection remains as the standby connection;
switch, in response to the signal strength of the first wireless connection not exceeding the threshold signal strength and the signal strength of the second wireless connection exceeding the threshold signal strength, the designation of the first wireless connection to the standby connection and the designation of the second wireless connection to the active connection; and
communicate with the second computing device via the active connection while maintaining the first wireless connection to the first computing device via the first antenna, wherein the first wireless connection remains as the standby connection.

13. The medium of claim 12, including instructions to cause the processor to determine whether a mechanism, in a peripheral device including the processor, is in a locked mode or an unlocked mode.

14. The medium of claim 13, including instructions to cause the processor to:
switch the designation of the active connection and the standby connection in response to the signal strength of the first wireless connection not exceeding the threshold signal strength, the signal strength of the second wireless connection exceeding the threshold signal strength, and the mechanism being in the unlocked mode; and
prevent the designation of the active connection and the standby connection in response to the signal strength of the first wireless connection not exceeding the threshold signal strength, the signal strength of the second wireless connection exceeding the threshold signal strength, and the mechanism being in the locked mode.

15. The medium of claim 12, including instructions to cause the processor to determine whether a predetermined gesture is performed by a peripheral device including the processor.

16. The medium of claim 15, including instructions to cause the processor to:
switch the designation of the active connection and the standby connection in response to the signal strength of the first wireless connection not exceeding the threshold signal strength, the signal strength of the second wireless connection exceeding the threshold signal strength, and the predetermined gesture being performed; and
prevent the designation of the active connection and the standby connection in response to the signal strength of the first wireless connection not exceeding the threshold signal strength, the signal strength of the second wireless connection exceeding the threshold signal strength, and the predetermined gesture not being performed.

17. A system comprising:
a first computing device;
a second computing device; and
a peripheral device comprising:
a first antenna having an active first wireless connection with the first computing device;
a second antenna having a standby second wireless connection with the second computing device; and
a controller to;
determine a signal strength of the first wireless connection and a signal strength of the second wireless connection;
compare the signal strength of the first wireless connection and the signal strength of the second wireless connection to a threshold signal strength;
switch, in response to the signal strength of the first wireless connection not exceeding the threshold signal strength and the signal strength of the second wireless connection exceeding the threshold signal strength, a designation of the first wireless connection to the standby connection and the designation of the second wireless connection to the active connection; and
communicate with the second computing device via the active connection while maintaining the first wireless connection to the first computing device via the first antenna, wherein the first wireless connection remains as the standby connection.

18. The system of claim 17; wherein the second computing device includes a camera to determine an orientation of a user with respect to the second computing device.

19. The system of claim 18, wherein the controller is to switch, in response to the signal strength of the first wireless connection not exceeding the threshold signal strength; the signal strength of the second wireless connection exceeding the threshold signal strength; and the orientation of the user being oriented towards the second computing device, the designation.

20. The system of claim 19, wherein:
the peripheral device is a computer mouse;
the second computing device includes a user interface; and
the computer mouse is to communicate with the second computing device via the active connection by manipulating a cursor on the user interface.
